(19) United States
(12) Patent Application Publication
(10) Pub. No.: US 2024/0044821 A1
(43) Pub. Date: Feb. 8, 2024

(54) COMBINED XRF ANALYSIS DEVICE

(71) Applicant: Shenzhen Angstrom Excellence Technology Co. Ltd, ShenZhen (CN)

(72) Inventors: Xuena ZHANG, ShenZhen (CN); Feng HONG, ShenZhen (CN); Cuihuan WANG, ShenZhen (CN)

(21) Appl. No.: 18/312,002

(22) Filed: May 4, 2023

(30) Foreign Application Priority Data
Aug. 2, 2022 (CN) 202210924236.9

(51) Int. Cl. G01N 23/223; G01N 23/2209

(52) U.S. Cl. CPC G01N 23/223; G01N 23/2209; G01N 2223/316

(57) ABSTRACT

Disclosed is a combined X-ray fluorescence (XRF) analysis device. According to embodiments, the combined X-ray fluorescence analysis device includes: a ray emission channel including a ray source; an energy dispersive XRF (EDXRF) detection channel including an EDXRF detector, and the EDXRF detector is configured to detect fluorescence at different energies within a certain energy range in fluorescence emitted by an object irradiated by a ray from the ray emission channel; and a wavelength dispersive XRF (WDXRF) detection channel including a WDXRF detector, and the WDXRF detector is configured to detect fluorescence at one or more specific wavelengths in the fluorescence emitted by the object irradiated by the ray from the ray emission channel.

### CROSS REFERENCE TO RELATED APPLICATION

This application claims priority to Chinese Patent Application No. 202210924236.9 filed on Aug. 2, 2022, the whole disclosure of which is incorporated herein by reference in its entirety.

### TECHNICAL FIELD

The present disclosure relates to the X-ray analysis technology, and in particular to a combined XRF analysis device that may apply different X-ray fluorescence (XRF) analysis technologies.

### BACKGROUND

An X-ray fluorescence (XRF) spectrometer and an analysis method thereof are widely used in numerous fields, such as semiconductor industry, to characterize a material through, for example, a trace element measurement, an element composition measurement, a film thickness measurement, and the like. XRF technology uses X-ray or gamma ray as a source to excite an internal orbital electron, so as to obtain a fluorescence signal of an element of interest. A material characteristic may be obtained by analyzing an excited fluorescence signal.

### SUMMARY

The objective of the present disclosure is at least partially to provide a combined XRF analysis device that may apply different X-ray fluorescence (XRF) analysis technologies.

According to an aspect of the present disclosure, there is provided a combined X-ray fluorescence (XRF) analysis device, including: a ray emission channel, wherein the ray emission channel includes a ray source; an energy dispersive XRF (EDXRF) detection channel, wherein the EDXRF detection channel includes an EDXRF detector, and the EDXRF detector is configured to detect fluorescence at different energies within a certain energy range in fluorescence emitted by an object irradiated by a ray from the ray emission channel; and a wavelength dispersive XRF (WDXRF) detection channel, wherein the WDXRF detection channel includes a WDXRF detector, and the WDXRF detector is configured to detect fluorescence at one or more specific wavelengths in the fluorescence emitted by the object irradiated by the ray from the ray emission channel.

### BRIEF DESCRIPTION OF THE DRAWINGS

The above and other objectives, features and advantages of the present disclosure will be more apparent through the following descriptions of embodiments of the present disclosure with reference to the accompanying drawings, in which,

FIG. 1 schematically shows a block diagram of a combined X-ray fluorescence (XRF) analysis device according to embodiments of the present disclosure;

FIG. 2 schematically shows a configuration of an energy dispersive XRF (EDXRF) analysis;

FIG. 3(a) to FIG. 3(d) schematically show various configurations of a wavelength dispersive XRF (WDXRF) analysis;

FIG. 4(a) to FIG. 4(d) schematically show various configurations of a combined XRF analysis device according to embodiments of the present disclosure; and

FIG. 5 schematically shows an optical channel arrangement of a combined XRF analysis device according to embodiments of the present disclosure in a top view.

Throughout the accompanying drawings, the same or similar reference numerals indicate the same or similar components.

### DETAILED DESCRIPTION OF EMBODIMENTS

Embodiments of the present disclosure will be described below with reference to the accompanying drawings. However, it should be understood that these descriptions are merely exemplary and are not intended to limit the scope of the present disclosure. Various schematic diagrams according to embodiments of the present disclosure are shown in the accompanying drawings. These drawings are not drawn to scale, wherein certain details are exaggerated and some details may be omitted for clarity of presentation. In addition, in the following descriptions, descriptions of well-known structures and technologies are omitted to avoid unnecessarily obscuring the concept of the present disclosure.

Terms used herein are for the purpose of describing embodiments only and are not intended to limit the present disclosure. The words “one”, “a (an)” and “the” used herein should also include the meaning of “more” and “a plurality of”, unless the context clearly indicates otherwise. In addition, the terms “comprising”, “including” and the like used here characterize a presence of said feature, step, operation and/or component, but do not preclude a presence or addition of one or more other features, steps, operations or components.

All terms (including technical and scientific terms) used here have the same meaning as commonly understood by those skilled in the art, unless otherwise defined. It should be noted that the terms used here should be construed to have the meaning consistent with the context of the present description, and should not be construed in an idealized or overly rigid manner.

Generally, an X-ray fluorescence (XRF) analysis may be performed in a form of energy dispersive (ED) or wavelength dispersive (WD), and a fluorescence intensity may be measured by way of energy or wavelength to obtain a fluorescence spectrum, thereby obtaining characteristics of an object.

The EDXRF technology may collect XRF signals of all elements in the object simultaneously through an energy resolution multi-channel analyzer. The EDXRF has advantages of simplicity and rapid acquisition of full spectrum. However, the acquisition of full spectrum is unfavorable in some cases, since all photons (for example, XRF photons, Compton scattering photons or Rayleigh scattering photons) scattered from the object are collected. This will lead to a high background signal, which is not conducive to weak signal detection. In addition, due to its poor energy resolution (˜100 eV), this indiscriminate collection is disadvantageous when co-existing elements in the object have characteristic lines that overlap or nearly overlap with each other.

In the WDXRF technology, all elements in the object are excited simultaneously. Different wavelengths are diffracted to different directions by optical devices such as a spectroscopic crystal, a monochromatic optical lens, a grating, etc., and are detected by detectors at specific angles. The WDXRF technology may only select XRF photons of interest (for example, by an angle at which a detector is located), so as to obtain a better signal-to-back ratio to achieve weak signal detection. In addition, the WDXRF technology has a better energy resolution (˜5 to 20 eV), so as to better analyze characteristic lines that overlap or nearly overlap with each other.

In some cases, the EDXRF technology may be more efficient, while in other cases, the WDXRF technology may be more advantageous. According to embodiments of the present disclosure, there is provided a combined XRF analysis device, which is capable of performing both EDXRF analysis and WDXRF analysis. Therefore, one or both of the two analysis technologies may be appropriately selected according to use scenarios.

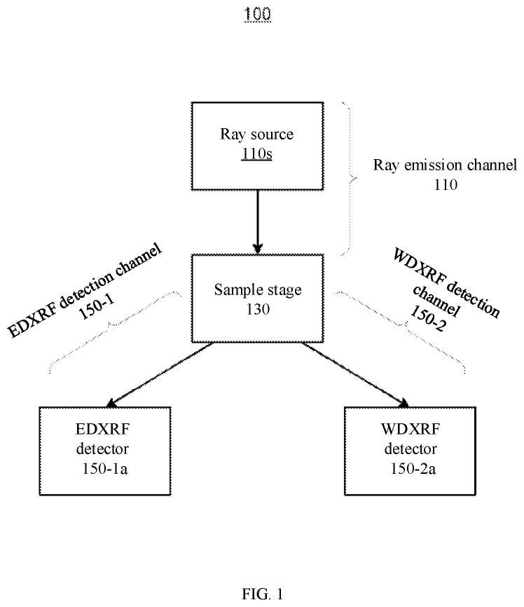

FIG. 1 schematically shows a block diagram of a combined XRF analysis device according to embodiments of the present disclosure.

As shown in FIG. 1, a combined XRF analysis device 100 according to embodiments of the present disclosure may include a ray emission channel 110, an EDXRF detection channel 150-1, and a WDXRF detection channel 150-2.

The ray emission channel 110 may be an optical channel that emits a ray to a sample S as an analysis object which is placed on a sample stage 130. The ray emission channel 110 may include a ray source 110s configured to generate a ray for XRF analysis, such as at least one selected from X-ray, gamma ray, and the like. The ray emission channel 110 may further include an optical device for optically manipulating the ray emitted from the ray source 110s, such as steering, converging/diverging, filtering, etc., so as to be able to irradiate a ray with desired characteristics (such as a size and a shape, etc., of a spot) to the sample S. Therefore, the ray emission channel 110 may be an optical channel from the ray source 110s to the sample stage 130 (more specifically, an irradiated region on the sample S on the sample stage 130).

For example, the ray source 110s may include an X-ray tube having a housing with vacuum or near vacuum inside and an electron beam emitter and a target material provided in the housing. The target material is bombarded by an electron beam emitted by the electron beam emitter to generate a ray. By selecting different target materials such as copper (Cu), iron (Fe), molybdenum (Mo), etc., rays of different energies (e.g., in KeV) or different wavelengths (or frequencies) may be generated. An intensity of the generated ray may be controlled by controlling a power of the electron beam.

The X-ray tube may be detachably installed on a mounting base. Therefore, the X-ray tube may be easily replaced, for example, in case of failure, or replaced with an X-ray tube with different characteristics (for example, an X-ray tube emitting a different energy ray or having a different target material) when necessary (for example, depending on characteristics of the sample S). For example, the X-ray tube may be a commercially available X-ray tube, so that a configuration of the combined XRF analysis device 100 may be easily adjusted as required.

According to embodiments of the present disclosure, the ray source 110s may operate in a monochrome or polychromatic mode. For example, the ray source 110s may generate monochromatic light or polychromatic light. Alternatively, it may generate polychromatic light or white light, combined with a filter to select (one or more) selected wavelength or band of the generated polychromatic light or white light.

An behavior of the X-ray depends on energy, and a ray with certain energy typically only work on a specific element. Therefore, the existing X-ray analysis system generally only has a single ray source that emits selected energy, or even if a plurality of sources are provided, one of them is selected for emission by a component selection. According to embodiments of the present disclosure, a plurality of ray sources 110s may be provided. Different ray sources may independently generate corresponding rays, such as the X-ray or the gamma ray. As described below, the plurality of ray sources 110s may be arranged in the same ray emission channel or in different ray emission channels. Two or more of the plurality of ray sources 110s may be switched on simultaneously. Therefore, a detected signal may be enhanced (for example, a signal strength is enhanced and/or a signal type is increased, etc.) to reduce a measurement time, and thus increasing a throughput.

The ray from the ray emission channel 110 is irradiated onto the sample S. For example, the sample S may be a silicon wafer (in which an integrated circuit has not been manufactured or has already been manufactured). In a case where there are a plurality of ray sources 110s, rays from different ray sources 110s may be focused on the same region of the sample S. Certainly, the rays may also be focused on different regions of the sample S.

The sample S is irradiated by the ray from the ray emission channel 110, and internal orbital electrons of the sample S may be excited by the ray. In order to fill a resulting vacancy, high-energy level electrons may jump to a low-energy orbit, thus releasing corresponding energy (that is, emitting corresponding fluorescence). The released energy (i.e., the emitted fluorescence) is related to an energy level structure of the sample S, thus may reflect material characteristics of the sample S. Here, the term “fluorescence” may refer to a radiation that emits lower energy due to absorption of radiation of specific energy. The sample S may generate fluorescence of different energies in response to the irradiation of different energy rays.

The EDXRF detection channel 150-1 may be an optical channel used to collect the fluorescence from the sample S for EDXRF analysis. The EDXRF detection channel 150-1 may include an EDXRF detector 150-1a. The EDXRF detector 150-1a has an energy resolution, and may detect a light signal intensity at different energies within a certain energy range (depending on characteristics of the EDXRF detector 150-1a), and thus may obtain a spectrum within the energy range. For example, the EDXRF detector 150-1a may include a silicon drift detector (SDD). The EDXRF detection channel 150-1 may further include an optical device for optically manipulating, such as steering, converging/diverging, filtering, etc., an optical signal entering the EDXRF detection channel 150-1, so that the entered optical signal may be detected by the EDXRF detector 150-1a. Therefore, the EDXRF detection channel 150-1 may be an optical channel from the sample stage 130 (more specifically, the irradiated region on the sample S on the sample stage 130) to the EDXRF detector 150-1a.

The WDXRF detection channel 150-2 may be an optical channel used to collect the fluorescence from the sample S for WDXRF analysis. The WDXRF detection channel 150-2 may include a wavelength dispersive device (for example, a spectroscopic crystal, a grating, etc. described below) to realize a wavelength-based optical splitting. For example, an optical signal entering the WDXRF detection channel 150-2 may travel in different directions according to the wavelengths due to the wavelength dispersive device. The WDXRF detection channel 150-2 may include a WDXRF detector 150-2a. The WDXRF detector 150-2a may be positioned to receive and detect an optical signal traveling in a specific direction, that is, an optical signal of a specific wavelength. For example, The WDXRF detector 150-2a may include a photon detector. Similarly, the WDXRF detection channel 150-2 may further include optical devices for steering, converging/diverging, filtering, etc. Therefore, the WDXRF detection channel 150-2 may be an optical channel from the sample stage 130 (more specifically, the irradiated region on the sample S on the sample stage 130) to the WDXRF detector 150-2a.

The combined XRF analysis device 100 may further include a driving device (not shown) to drive an optical device in each component to conduct orientation, focusing and other actions, drive a moving part (for example, a mounting base on which each component is installed, etc.) in each component to move, and so on, so as to realize an effective optical coupling among the ray emission channel 110 and the EDXRF detection channel 150-1 and the WDXRF detection channel 150-2 (via the sample S). For example, the driving device may drive at least one selected from the mounting base of each component, the optical device in each component, the sample stage 130, etc. to perform translation, rotation, pitching and other actions to realize required focus and required incidence and/or exit angles.

The combined X-ray device 100 may further include a control device (not shown). The control device may include a processor or a microprocessor, a field programmable gate array (FPGA), an application specific integrated circuit (ASIC), a single-chip computer, etc. The control device may control an overall operation of the combined XRF analysis device 100. The controller device may control operations of the ray emission channel 110, the sample stage 130, the EDXRF detection channel 150-1 and the WDXRF detection channel 150-2, respectively. For example, the control device may control the above-mentioned driving device, so that the ray emission channel 110, the sample stage 130, the EDXRF detection channel 150-1 and the WDXRF detection channel 150-2 are optically aligned, that is, the ray from the ray emission channel 110 may be effectively incident to the target region of the sample S placed on the sample stage 130, and the fluorescence from the sample S may be effectively received by the EDXRF detection channel 150-1 and the WDXRF detection channel 150-2. The control device may control at least two (for example, three or more) of the ray sources 110s (in a case of a plurality of ray sources 110s) to be switched on simultaneously, and the rays emitted by the switched-on ray sources may be incident onto the (same) target region of the sample S. The control device may select different ray sources to switch on according to a predetermined standard or user input (for example, according to characteristics of the sample, or according to the purpose of analysis). The control device may further control the ray source 110s, so that the switched-on ray source may generate a ray with a certain intensity, so that the EDXRF detection channel 150-1 and the WDXRF detection channel 150-2 may obtain detection signals with good quality (for example, a signal-to-noise ratio thereof is higher than a predetermined threshold). The control device may generate an analysis result (for example, at least one selected from a composition, a content of each component, a surface film thickness, and the like of the sample S) according to the detection signals of the EDXRF detection channel 150-1 and the WDXRF detection channel 150-2. The control device may display the analysis result to the display device (not shown), store the analysis result in a storage device, or send the analysis result to a remote server. The control device may further control the sample stage 130, so that the sample S may be scanned to detect different regions of the sample S.

The control device may be realized as a general-purpose or special-purpose computer. The general-purpose or special-purpose computer may execute program instructions to perform various operations described in the present disclosure. Such program instructions may be stored in a local memory, or may be downloaded from a remote memory via a wired or wireless connection. Alternatively, operations described in the present disclosure may be performed by the control device requesting the remote server, or some of the operations may be performed by the control device, while others may be performed by other controllers or servers connected with the control device.

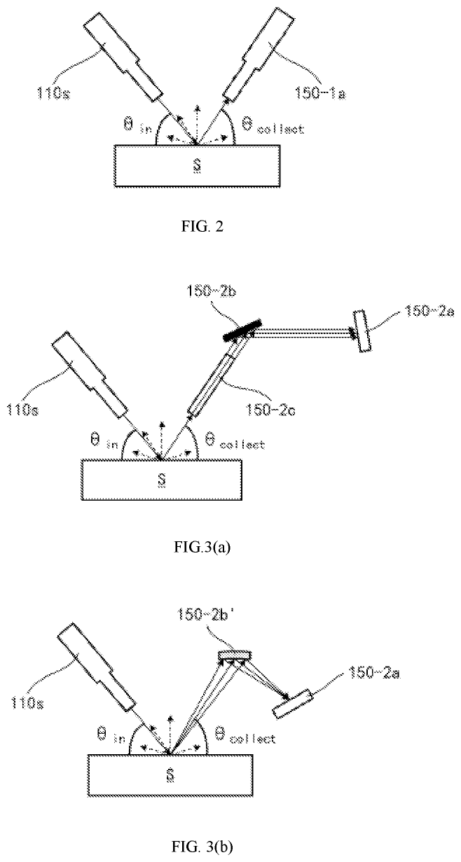

FIG. 2 schematically shows a configuration of the EDXRF analysis.

As shown in FIG. 2, the ray from the ray emission channel 110 may be incident onto the sample S at a certain angle θᵢₙ relative to a surface of the sample S. For example, the ray emitted by the ray source 110s may be irradiated onto (the target region of) the sample S in a required way (for example, a focusing mode) through the optical device in the ray emission channel (for example, capillary focusing optical device or DCC monochromatic optical lens, etc.). The fluorescence generated by the sample S due to irradiation of the ray may be emitted toward all directions.

The EDXRF detection channel 150-1 may collect the optical signal at a certain angle θ_{collect} relative to the surface of the sample S. Here, in the fluorescence generated by the sample S in all directions, except the fluorescence entering the EDXRF detection channel 150-1 at the collection angle θ_{collect} shown by a solid line with an arrow, the fluorescence in other directions is shown by a dotted line with an arrow. This is only to clearly show the collection of relevant fluorescence, and does not mean that the fluorescence along different directions must have different properties. The same is true in the following illustration. The collected optical signal may be detected by the EDXRF detector 150-1a to obtain the spectrum within a certain energy range. Depending on the elements contained in the sample, the sample S may exhibit fluorescence intensity peaks (i.e., characteristic lines) at one or more specific energies. If at least some of the characteristic lines of different elements in the sample S are within a working energy range of the EDXRF detector 150-1, corresponding characteristic lines of these elements may be detected simultaneously.

An incidence angle θᵢₙ may range from close to 0° (grazing incidence) to 90° (normal incidence), and the collection angle θ_{collect} may range from close to 0° (grazing emission) to 90° (normal emission). According to embodiments, θ_{collect} may be changed through the above-mentioned driving device, so that signals with good quality (for example, high signal-to-noise ratio) may be received.

In FIG. 2, a single ray source 110s is shown. However, as described above, more than one ray source (for example, rays of different wavelengths or bands may be emitted to analyze different elements simultaneously; or rays of the same wavelength or band may be emitted to enhance the signal strength) may be switched on simultaneously. These switched-on ray sources may irradiate the same target region of the sample S. The fluorescence generated by the sample S due to the irradiation of these ray generating devices may be collected by a single or more detectors, and this will be explained in further detail below.

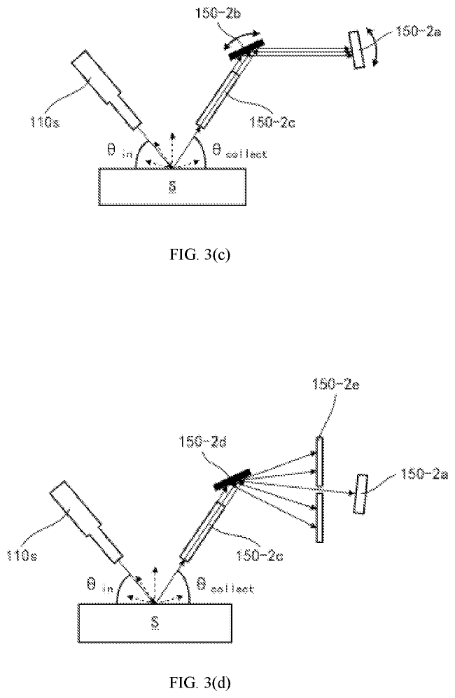

FIG. 3(a) to FIG. 3(d) schematically show various configurations of the wavelength dispersive XRF (WDXRF) analysis.

FIG. 3(a) schematically shows a flat/single curved type spectroscopic crystal configuration. As shown in FIG. 3(a), similarly, the ray from the ray emission channel is incident onto the sample S at a certain angle θᵢₙ. The ray emission channel may include optical devices such as the capillary focusing optical device or the DCC monochromatic optical lens as well. The fluorescence generated by the sample S due to irradiation of the ray may be emitted toward all directions.

The WDXRF detection channel 150-2 may collect the optical signal at a certain angle θ_{collect} relative to the surface of the sample S. The WDXRF detection channel 150-2 may be provided with a flat/single curved type spectroscopic crystal 150-2b as the above-mentioned wavelength dispersive device. Diffractive optical splitting may be realized by the spectroscopic crystal according to Bragg's law. Specifically, when the light is incident onto the spectroscopic crystal at a certain angle, light of wavelength comply with Bragg's law may be detected at a corresponding exit angle, while light of other wavelengths will not be detected or substantially not detected. The incident angle of the light incident onto the spectroscopic crystal and a structure of the spectroscopic crystal (for example, spacing between surfaces) may be appropriately selected, and a location of the WDXRF detector 150-2a may be set accordingly to realize the detection of the optical signals of one or more specific wavelengths (for example, a wavelength corresponding to a characteristic line of a desired detection element). Therefore, an interference of optical signals of other wavelengths to the optical signal of the wavelength to be detected may be suppressed, which is conducive to weak signal detection. When the spectroscopic crystal is the flat/single curved type spectroscopic crystal 150-2 as shown in FIG. 3(a), the WDXRF detection channel 150-2 may further be provided with a collimating device 150-2c to collimate the light entering the WDXRF detection channel 150-2, and the collimated light is incident onto the flat/single curved type spectroscopic crystal 150-2 at a certain angle. For example, the collimating device 150-2c may be a Soller slit or a collimating capillary.

Similarly, the incidence angle θᵢₙ may range from close to 0° (grazing incidence) to 90° (normal incidence). The collection angle θ_{collect} may range from close to 0° (grazing emission) to 90° (normal emission).

FIG. 3 (b) schematically shows a configuration of a hyperbolic spectroscopic crystal. The configuration of FIG. 3 (b) is similar to the configuration of FIG. 3 (a). A main difference is that the spectroscopic crystal is a hyperbolic spectroscopic crystal 150-2b′. In this case, the WDXRF detection channel 150-2 may not be provided with the collimating device, since the hyperbolic spectroscopic crystal 150-2b′ may have a focusing capability.

FIG. 3(c) schematically shows a scanning type configuration. The configuration of FIG. 3(c) is similar to the configuration of FIG. 3(a). A main difference is that the driving device may drive the spectroscopic crystal 150-2b to rotate, thus the light from the collimating device 150-2c may be incident onto the spectroscopic crystal 150-2b at different incidence angles. At different incident angles, light of different wavelengths may comply with Bragg's law. The driving device may drive the WDXRF detector 150-2a to rotate accordingly to detect an optical signal of a corresponding wavelength at a corresponding exit angle. Thus, characteristic lines of a plurality of wavelengths (for example, characteristic lines of different elements) may be detected. Considering a factor of optical alignment, the spectroscopic crystal 150-2b may be a flat type spectroscopic crystal under the scanning type configuration.

FIG. 3(d) schematically shows a grating type configuration. The configuration of FIG. 3(d) is similar to the configuration of FIG. 3(a). A main difference is that a grating 150-2d is used as the wavelength dispersive device instead of the spectroscopic crystal 150-2b. After the light collimated by the collimating device 150-2c is incident onto the grating 150-2d, the grating 150-2d may make light of different wavelengths travel toward different directions based on diffraction. That is, the grating 150-2d may realize a spatial separation of light of different wavelengths. Therefore, the detection of the light with a specific wavelength may be realized by providing a detector in the direction of travel of light with a specific wavelength. For example, a diaphragm 150-2e, such as a slit, may be provided to select light traveling in a specific direction, and the WDXRF detector 150-2a may be arranged after the diaphragm 150-2e to detect light passing through the diaphragm 150-2e.

Similarly, although a single ray source 110s is shown in FIG. 3(a) to FIG. 3(d), more than one ray source may be switched on simultaneously.

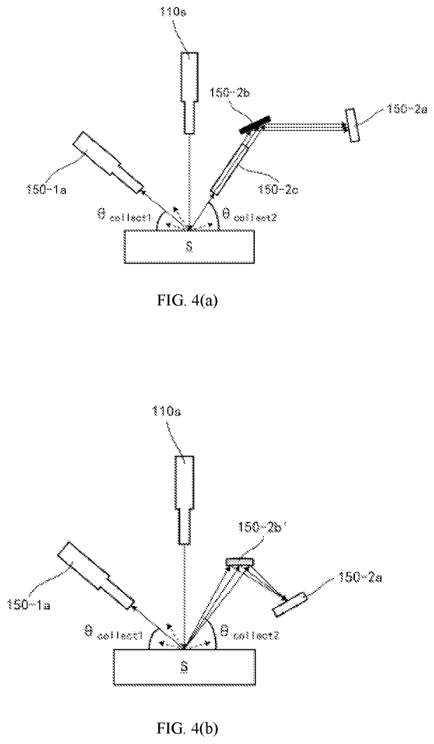

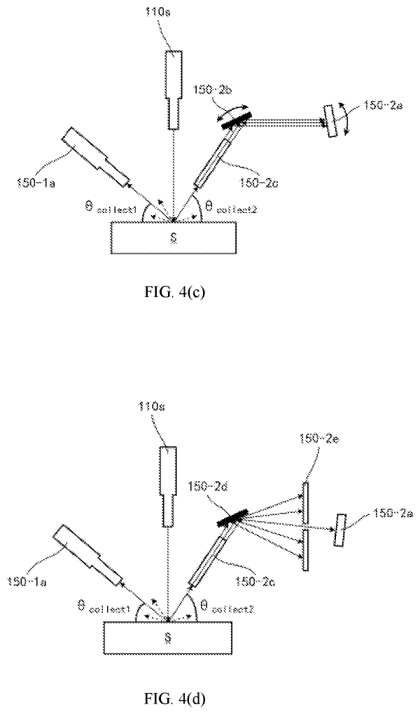

FIG. 4(a) to FIG. 4(d) schematically show various configurations of a combined XRF analysis device according to embodiments of the present disclosure.

FIG. 4(a) schematically shows a combination of the EDXRF technology plus the WDXRF technology with the flat/single curved type spectroscopic crystal configuration.

As shown in FIG. 4 (a), the ray from the ray emission channel is incident onto the sample S at a certain angle θᵢₙ. Here, a situation of θᵢₙ=90° (i.e., normal incidence) is shown. However, the present disclosure is not limited to this. The incidence angle θᵢₙ may deviate from 90° and be obliquely incident onto the sample S. Similarly, the present disclosure is not limited to a single light source 110s. The EDXRF detection channel 150-1 may collect the optical signal at a certain angle θ_{collect1}, and the WDXRF detection channel 150-2 may collect the optical signal at a certain angle θ_{collect2}. In this example, the WDXRF detection channel 150-2 may have the flat/single curved type spectroscopic crystal configuration as described above with reference to FIG. 3(a).

FIG. 4(b) schematically shows a combination of the EDXRF technology plus the WDXRF technology with the hyperbolic type spectroscopic crystal configuration. The configuration shown in FIG. 4(b) is similar to the configuration in FIG. 4(a). A main difference is that the WDXRF detection channel 150-2 has the hyperbolic spectroscopic crystal configuration as described above with reference to FIG. 3(b).

FIG. 4(c) schematically shows a combination of the EDXRF technology plus the WDXRF technology with the scanning type configuration. The configuration shown in FIG. 4(c) is similar to the configuration in FIG. 4(a). A main difference is that the WDXRF detection channel 150-2 has the scanning type configuration as described above with reference to FIG. 3(c).

FIG. 4(d) schematically shows a combination of the EDXRF technology and the WDXRF technology with the grating type configuration. The configuration shown in FIG. 4(d) is similar to the configuration shown in FIG. 4(a). A main difference is that the WDXRF detection channel 150-2 has the grating type configuration as described above with reference to FIG. 3(d).

Although FIG. 4(a) to FIG. 4(d) show that there is only one ray emission channel, one EDXRF detection channel and one WDXRF detection channel in each configuration, the present disclosure is not limited to this. According to embodiments, two or more ray emission channels, two or more EDXRF detection channels, and/or two or more WDXRF detection channels may be provided. For example, different ray emission channels may emit rays of different wavelengths or bands, different EDXRF detection channels may detect optical signals of different energy ranges, and different WDXRF detection channels may detect optical signals of different wavelengths.

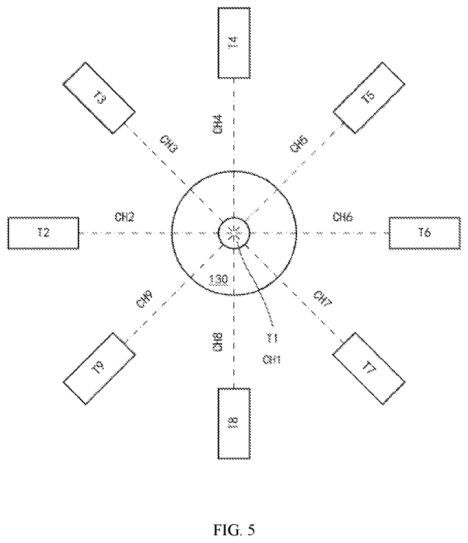

FIG. 5 schematically shows an optical channel arrangement of a combined XRF analysis device according to embodiments of the present disclosure in a top view.

As shown in FIG. 5, relative to the sample stage 130, light-emitting devices (for example, the above-mentioned radiation sources 110s) or light-terminating devices (for example, the above-mentioned EDXRF detector 150-1a, WDXRF detector 150-2a) T1, T2, T3, T4, T5, T6, T7, T8, T9 may be provided. Optical channels CH1, CH2, CH3, CH4, CH5, CH6, CH7, CH8 and CH9 may be defined between the light-emitting devices or light-terminating devices and the sample stage. By providing fewer or more light-emitting devices or light-terminating devices, fewer or more optical channels may be provided.

In the light-emitting devices or light-terminating devices T1 to T9, the light-emitting device or light-terminating device T1 may directly face the sample stage 130 so as to be arranged in a normal direction of the sample stage 130. Other light-emitting devices or light-terminating devices T2 to T9 may be arranged obliquely relative to the sample stage 130, and may, for example, be spaced from each other along a circumferential direction of the sample stage 130. Although the obliquely arranged light-emitting devices or light-terminating devices T2 to T9 are shown in FIG. 5 as located outside the sample stage 130 in the top view, the present disclosure is not limited to this. For example, one or more of the light-emitting devices or light-terminating devices T2 to T9 arranged obliquely may be (at least partially) arranged above the sample stage 130, and may overlap with the sample stage 130 in the top view.

At least one of the light-emitting devices or light-terminating devices T1 to T9 may be the ray source, and therefore corresponding optical channels in the optical channels CH1 to CH9 may be ray emission channels. In the embodiments shown in FIG. 4(a) to FIG. 4(d), the optical channel CH1 in the normal direction of the sample stage 130 is the ray emission channel. However, other optical channels in CH2 to CH9 may also be used as ray emission channels.

At least two of the light-emitting devices or light-terminating devices T1 to T9 may be the EDXRF detector and the WDXRF detector, respectively, and therefore at least two corresponding optical channels in the optical channels CH1 to CH9 may be the EDXRF detection channel and the WDXRF detection channel, respectively. In the embodiments shown in FIG. 4(a) to FIG. 4(d), the EDXRF detection channel and the WDXRF detection channel are arranged obliquely relative to the sample stage 130. However, the optical channel CH1 in the normal direction of the sample stage 130 may also be used as the EDXRF detection channel or the WDXRF detection channel. In a case where a plurality of WDXFR detection channels are provided, different WDXRF detection channels may have different configurations, such as the configurations described above in combination with FIG. 3(a) to FIG. 3(d).

According to embodiments of the present disclosure, according to use scenarios, one or more EDXRF detection channels may be appropriately selected for EDXRF analysis, one or more WDXRF detection channels may be appropriately selected for WDXRF analysis, or one or more EDXRF detection channels and one or more WDXRF detection channels may be appropriately respectively selected for EDXRF analysis and WDXRF analysis. The analysis results of different detection channels may complement or enhance each other. For example, an energy range or wavelength range of fluorescence peak may be determined according to the result of EDXRF analysis, and a more accurate analysis may be performed in the determined energy range or wavelength range in WDXRF analysis. For another example, the position of the characteristic line may be determined according to the results of EDXRF analysis and WDXRF analysis so as to suppress an error of the detector, such as drift, etc.

Therefore, the same measurement tool may be capable of performing both EDXRF analysis and WDXRF analysis. One or both of the two analysis technologies may be appropriately selected according to use scenarios. In addition, different technologies may be verified with each other to further improve a measurement accuracy.

The ray emission channel, the EDXRF detection channel and the WDXRF detection channel may be arranged differently. More specifically, the ray emission channel, the EDXRF detection channel and the WDXRF detection channel may be respectively arranged in the following optical channels: a first optical channel directly facing the object, and a plurality of second optical channels arranged obliquely relative to the object. For example, the ray emission channel may be arranged in the first optical channel, and the EDXRF detection channel and the WDXRF detection channel may be respectively arranged in different second optical channels. Alternatively, the ray emission channel may be arranged in the second optical channel, and the EDXRF detection channel and the WDXRF detection channel may be respectively arranged in different ones of the first optical channel and other second optical channels of the plurality of second optical channels. Alternatively, the ray emission channel, the EDXRF detection channel and the WDXRF detection channel may be respectively arranged in different second optical channels.

The combined XRF analysis device according to embodiments of the present disclosure may have a multi-source design. For example, the ray emission channel may include a plurality of ray sources, wherein two or more of the ray sources may be configured to generate corresponding rays to irradiate the object. Alternatively or additionally, a plurality of ray emission channels may be provided, wherein two or more of the ray emission channels may be configured to emit corresponding rays to irradiate the object. Rays from different ray sources or different ray emission channels may be irradiated onto the same target region of the object. The irradiated ray may be monochromatic light or polychromatic light.

The multi-source design may collect more signals simultaneously, and therefore may enhance the signals to improve a throughput.

The WDXRF detection channel may have different configurations, such as at least one of flat/single curved/hyperbolic type spectroscopic crystal configuration, scanning type configuration or grating type configuration, so as to adapt to different measurement scenarios and achieve different measurement purposes.

Embodiments of the present disclosure have been described above. However, these embodiments are for illustrative purposes only, and are not intended to limit the scope of the present disclosure. The scope of the present disclosure is defined by the appended claims and their equivalents. Without departing from the scope of the present disclosure, those skilled in the art may make various substitutions and modifications, and these substitutions and modifications should all fall within the scope of the present disclosure.

What is claimed is:

1. A combined X-ray fluorescence (XRF) analysis device, comprising:
a ray emission channel, wherein the ray emission channel comprises a ray source;
an energy dispersive XRF (EDXRF) detection channel, wherein the EDXRF detection channel comprises an EDXRF detector, and the EDXRF detector is configured to detect fluorescence at different energies within a certain energy range in fluorescence emitted by an object irradiated by a ray from the ray emission channel; and
a wavelength dispersive XRF (WDXRF) detection channel, wherein the WDXRF detection channel comprises a WDXRF detector, and the WDXRF detector is configured to detect fluorescence at one or more specific wavelengths in the fluorescence emitted by the object irradiated by the ray from the ray emission channel.

2. The XRF analysis device according to claim 1, wherein the ray emission channel, the EDXRF detection channel and the WDXRF detection channel are respectively arranged in different optical channels of a first optical channel directly facing the object and a plurality of second optical channels arranged obliquely relative to the object.

3. The XRF analysis device according to claim 2, wherein the ray emission channel is arranged in the first optical channel, and the EDXRF detection channel and the WDXRF detection channel are respectively arranged in different second optical channels.

4. The XRF analysis device according to claim 2, wherein the ray emission channel is arranged in one of the plurality of second optical channels, and the EDXRF detection channel and the WDXRF detection channel are respectively arranged in different optical channels of the first optical channel and other second optical channels of the plurality of second optical channels.

5. The XRF analysis device according to claim 1, wherein the ray emission channel comprises a plurality of ray sources, and two or more of the plurality of ray sources are configured to generate corresponding rays to irradiate the object.

6. The XRF analysis device according to claim 1, comprising a plurality of the ray emission channels, and two or more of the ray emission channels are configured to emit corresponding rays to irradiate the object.

7. The XRF analysis device according to claim 1, wherein the WDXRF detection channel comprises at least one of the followings:
a flat type spectroscopic crystal WDXRF detection channel, comprising:
a collimating device configured to collimate the fluorescence from the object, wherein the collimated fluorescence is incident onto a flat type spectroscopic crystal;
the flat type spectroscopic crystal configured to irradiate fluorescence of a specific wavelength in the fluorescence incident onto the flat-type spectroscopic crystal toward a light detector; and
the light detector configured to receive the fluorescence of the specific wavelength from the flat type spectroscopic crystal;
a single curved type spectroscopic crystal WDXRF detection channel, comprising:
a collimating device configured to collimate the fluorescence from the object, wherein the collimated fluorescence is incident onto a single curved type spectroscopic crystal;
the single curved type spectroscopic crystal configured to irradiate fluorescence of a specific wavelength in the fluorescence incident onto the single curved type spectroscopic crystal toward a light detector; and
the light detector configured to receive the fluorescence of the specific wavelength from the single curved type spectroscopic crystal;
a hyperbolic type spectroscopic crystal WDXRF detection channel, comprising:
a hyperbolic type spectroscopic crystal configured to irradiate fluorescence of a specific wavelength in the fluorescence incident onto the hyperbolic type spectroscopic crystal toward a light detector; and
the light detector configured to receive the fluorescence of the specific wavelength from the hyperbolic type spectroscopic crystal;
a scanning type WDXRF detection channel, comprising:
a spectroscopic crystal configured to irradiate fluorescence of a specific wavelength in the fluorescence incident onto the spectroscopic crystal toward a light detector; and
the light detector configured to receive the fluorescence of the specific wavelength from the spectroscopic crystal,
wherein the spectroscopic crystal and the light detector are configured to rotate so as to achieve scanning of different specific wavelengths;
a grating type WDXRF detection channel, comprising:
a collimating device configured to collimate the fluorescence from the object, wherein the collimated fluorescence is incident onto a grating;
the grating configured to irradiate fluorescence of different wavelengths in the fluorescence incident onto the grating toward different directions;
a diaphragm configured for passing of fluorescence irradiated toward a specific direction; and
a light detector configured to receive the fluorescence passing the diaphragm.

8. The XRF analysis device according to claim 5, wherein the plurality of ray sources in the ray emission channel are configured to respectively emit rays to irradiate a same target region of the object.

9. The XRF analysis device according to claim 6, wherein the plurality of ray emission channels are configured to respectively emit rays to irradiate a same target region of the object.

10. The XRF analysis device according to claim 1, wherein the ray from the ray emission channel is monochromatic light or polychromatic light.
